(19) United States
(12) Patent Application Publication
(10) Pub. No.: US 2009/0255438 A1
(43) Pub. Date: Oct. 15, 2009

(54) THERMALLY CURABLE ENCAPSULANT COMPOSITION FOR INKJET PRINT CARTRIDGE

(76) Inventors: David Christopher Graham, Lexington, KY (US); Gary Anthony Holt, JR., Lexington, KY (US); Richard Leo Hubert, II, Lexington, KY (US); Gerald Wayne McComas, Lexington, KY (US); Girish Shivaji Patil, Lexington, KY (US); Richard D. Wells, Westerville, OH (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/103,307

(22) Filed: Apr. 15, 2008

(51) Int. Cl. C09D 5/08

(52) U.S. Cl. 106/14.42; 106/14.05; 106/14.41

(57) ABSTRACT

Disclosed is a micro-fluid ejection head of an inkjet print cartridge. More specifically, disclosed is a thermally curable encapsulant composition for use in the micro-fluid ejection head of the inkjet print cartridge. The encapsulant composition includes from about 1.5 to about 95 percent by weight of one or more cross-linkable epoxy resins having a rigid backbone. Further, the encapsulant composition includes about 0.1 to about 35 percent by weight of one or more thermal curative agents. Further disclosed is a method for protecting the micro-fluid ejection head using the encapsulant composition.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Disclosure

The present disclosure generally relates to inkjet print cartridges employed in inkjet printers, and more specifically, to a thermally curable encapsulant composition for application on inkjet surfaces of the inkjet print cartridges to increase effective lifetime thereof.

2. Description of the Related Art

In general, an inkjet print cartridge, employed in an inkjet printer, includes a fluid body, an electrical circuit or other electrical connections, and one or more micro-fluid ejection heads. Usually, the fluid body may include one or more ink chambers with each ink chamber including a fluid, such as ink. Further, the electrical circuit may be disposed onto the fluid body. Such an electrical circuit may either be a flexible circuit or a non-flexible circuit. More specifically, a portion of the electrical circuit, such as the flexible circuit, may be disposed onto an operative surface of the fluid body. The term ‘operative surface,’ as used herein, refers to a surface of the inkjet print cartridge that may be in contact with a printing medium. Suitable examples of the printing medium may include, but are not limited to, non-woven substrates, canvas substrates and cellulose substrates. Moreover, a plurality of contact pads may be attached onto a first portion of the flexible circuit such that the plurality of contact pads is in an electrical contact with a second portion of the flexible circuit using electrical traces embedded therein. Further, the second portion of the flexible circuit is in direct contact with the one or more micro-fluid ejection heads of the inkjet print cartridge.

A micro-fluid ejection head, employed in the inkjet print cartridge, includes a substrate with a plurality of actuators, and a nozzle plate having a plurality of nozzles with a fluid-ejection surface encompassing the plurality of nozzles. Further, the substrate and the fluid-ejection surface are configured in a special arrangement such that each of the plurality of nozzles is directly above at least one of the plurality of actuators. The aforementioned arrangement creates a plurality of bubble chambers in space between the substrate and the fluid-ejection surface of the micro-fluid ejection head.

During a typical inkjet printing process, the fluid body supplies ink from the one or more ink chambers to the micro-fluid ejection head. More specifically, the fluid body supplies the ink to the micro-fluid ejection head through a plurality of fluid-receiving openings thereof. On receiving the ink, the micro-fluid ejection head transfers it to the plurality of bubble chambers. At almost the same instance, the plurality of actuators, such as resistors, produce an energy pulse, such as a heat energy pulse, that vaporizes the ink to form ink bubbles in each of the plurality of the bubble chambers. The ink bubbles rise up through each of the plurality of bubble chambers and expel ink droplets therefrom. Consequently, the plurality of bubble chambers ejects the ink droplets through the plurality of nozzles onto the printing medium to get a printed image thereon. Further, controlling the plurality of actuators may regulate the aforementioned ejection process. Usually, a controlling circuit employed in the inkjet printer may control performance of the plurality of actuators. Such a controlling circuit is in an electrical contact with the plurality of actuators through the contact pads, the electrical traces, and electrical connections that connect the electrical traces with the substrate.

Typically, the electrical connections associate bond pads configured on the substrate with the contact pads through electrical wires. The bond pads provide various attachment points on the substrate, whereas the contact pads provide various attachment points on the flexible circuit. The electrical wires connect the bond pads and the contact pads to provide an electrical continuity between the substrate and the flexible circuit.

However, it has been observed that during an inkjet printing process that employs use of such an above-described inkjet print cartridge in an inkjet printer, the electrical connections may undergo wearing-out or abrasion over a period due to a recurring use thereof. Further, the electrical connections may corrode due to a frequent contact with fluids, such as ink. Such abrasion and corrosion may also be accompanied by short-circuiting of the electrical connections, thereby impeding the normal functioning of the inkjet printer. Therefore, it is desired to encapsulate electrical components of the inkjet print cartridge that include the electrical circuit, the electrical connections, and the electrical traces for protection or insulation purposes.

In order to eliminate any likelihood of abrasion and corrosion, the aforementioned electrical components of the inkjet print cartridge are encapsulated or protected with an encapsulant composition. Such an encapsulation technique includes dispensing the encapsulant composition onto the aforementioned electrical components, and then curing the encapsulant composition by application of heat or ultraviolet (UV) radiations. More specifically, the encapsulant composition is disposed adjacent to inkjet print cartridge surfaces, such as a surface of the nozzle plate, and more specifically, to a surface of a photo imageable nozzle plate (hereinafter referred to as ‘PINP’), such that the encapsulant composition is capable of encompassing the electrical components. Such encapsulant compositions are desired to possess good mechanical adhesion to inkjet print cartridge surfaces in addition to possessing good ink resistance and dimensional control properties.

It should be understood that the adhesion properties and the ink resistance properties of the encapsulant composition are related to corrosion of the inkjet print cartridge and electrical components thereof. For example, use of an encapsulant composition with a poor ink resistance and a poor adhesion leads to a poor performance for protection of the inkjet print cartridge and electrical components thereof from corrosion. Further, the ink resistance properties are attributed by type of material used for preparing the encapsulant composition.

Similarly, dimensional control properties of the encapsulant composition are related to scrap production during manufacturing setting of the inkjet print cartridge and electrical components thereof. For instance, use of an encapsulant composition with poor dimensional control properties leads to scrap during the manufacturing setting due to out of specification pieces and an uncontrollable flow of the encapsulant composition across components of the inkjet print cartridge, such as an uncontrollable flow of the encapsulant composition from the nozzle plate into the plurality of nozzles. It should be understood that the dimensional control of the encapsulant composition is obtained by subjecting the encapsulant composition to a curing process so as to shorten the time required to reach minimum viscosity for the encapsulant composition. Further, the encapsulant composition needs to be dispensed in small spaces of the inkjet print cartridge so as to be held to tighter dimensional tolerances. Furthermore, the flow properties of the encapsulant composition depend on chemical and physical structure and composition thereof. Therefore, depending on type of the curing process, the requirements for flow and deformation of the encapsulant composition may vary. For example, if the material of the encapsulant composition is a cross-linkable, or a thermosetting material, then cure parameters may affect the flow and deformation of the encapsulant composition, thereby regulating final dimensions and tolerance for placement of the encapsulant composition in the inkjet print cartridge.

In addition to the aforementioned properties, encapsulant compositions including materials with a low ionic content are desirable to increase robustness for protection against corrosion.

Previously disclosed encapsulant compositions included materials that were either UV curable with good dimensional control but poor ink resistance properties or thermally curable with good ink resistance but poor dimensional control properties. In addition, conventional encapsulant compositions incorporating resins with a flexible backbone exhibited a poor adhesion to the PINP surfaces. For example, conventional UV curable encapsulant compositions, made from an acrylate material when used as topside encapsulants provide good dimensional control. However, the UV curing is not very effective for curing shadow areas that represent areas not in direct contact with UV radiations. Additionally, due to ink-soak capabilities of the acrylate material, the encapsulant compositions possess poor ink resistance properties. Alternatively, conventional thermally curable encapsulant compositions show a drop in viscosity after an application of thermal energy, thereby exhibiting poor dimensional control properties thereof. In addition, most of the conventional thermally curable encapsulant compositions are incapable of withstanding high temperatures and exhibit a high average edge migration before and after curing. Such a high average edge migration affects the encapsulant compositions' placement tolerance. Therefore, it has always been challenging to prepare an encapsulant composition that serves as an ideal encapsulating agent for use in inkjet print cartridges.

Accordingly, there is a need to develop an encapsulant composition for effectively protecting electrical components of an inkjet print cartridge. Further, the encapsulant composition should exhibit good ink resistance, good dimensional control properties, and low average edge migration upon thermal curing in order to provide improved insulation or protection to the electrical components. Furthermore, the encapsulant composition should provide better adhesion to inkjet print cartridge surfaces, such as PINP surfaces. In addition, the encapsulant composition should increase effective shelf life of the inkjet print cartridge.

### SUMMARY OF THE DISCLOSURE

In view of the foregoing disadvantages inherent in the prior art, the general purpose of the present disclosure is to provide a thermally curable encapsulant composition for a micro-fluid ejection head of an inkjet print cartridge, to include all the advantages of the prior art, and to overcome the drawbacks inherent therein.

In one aspect, the present disclosure provides a thermally curable encapsulant composition for a micro-fluid ejection head of an inkjet print cartridge. The encapsulant composition includes from about 1.5 to about 95 percent by weight of at least one cross-linkable epoxy resin having a rigid backbone. Further, the encapsulant composition includes from about 0.1 to about 35 percent by weight of at least one thermal curative agent. Moreover, the encapsulant composition exhibits a glass transition temperature of greater than or equal to about 90 degrees Celsius upon curing at a temperature of greater than or equal to about 90 degrees Celsius.

Further, in another aspect, the present disclosure provides a method for protecting a micro-fluid ejection head of an inkjet print cartridge. The method includes disposing a thermally curable encapsulant composition adjacent to a fluid-ejection surface of the micro-fluid ejection head of the inkjet print cartridge. Further, the method includes curing the encapsulant composition by heating the encapsulant composition to a temperature greater than or equal to about 90 degrees Celsius. The encapsulant composition includes from about 1.5 to about 95 percent by weight of at least one cross-linkable epoxy resin having a rigid backbone. Further, the encapsulant composition includes from about 0.1 to about 35 percent by weight of at least one thermal curative agent. Moreover, the encapsulant composition exhibits a glass transition temperature of greater than or equal to about 90 degrees Celsius.

In yet another aspect, the present disclosure provides a micro-fluid ejection head of an inkjet print cartridge. The micro-fluid ejection head includes a thermally curable encapsulant composition disposed adjacent to a fluid ejection surface of the micro-fluid ejection head. The encapsulant composition includes from about 1.5 to about 95 percent by weight of at least one cross-linkable epoxy resin having a rigid backbone. Further, the encapsulant composition includes from about 0.1 to about 35 percent by weight of at least one thermal curative agent. Moreover, the encapsulant composition exhibits a glass transition temperature of greater than or equal to about 90 degrees Celsius upon curing at a temperature of greater than or equal to about 90 degrees Celsius.

### BRIEF DESCRIPTION OF THE DRAWINGS

The above-mentioned and other features and advantages of this disclosure, and the manner of attaining them, will become more apparent and the disclosure will be better understood by reference to the following description of embodiments of the disclosure taken in conjunction with the accompanying drawings, wherein:

FIG. 1 is a perspective view of an inkjet print cartridge according to an embodiment of the present disclosure;

FIG. 2 is a top view of a portion of an inkjet print cartridge with an encapsulant composition according to an embodiment of the present disclosure; and

FIG. 3 is a cross-sectional side view (not to scale) of a portion of an inkjet print cartridge with an encapsulant composition according to an embodiment of the present disclosure.

### DETAILED DESCRIPTION

It is to be understood that various omissions and substitutions of equivalents are contemplated as circumstances may suggest or render expedient, but these are intended to cover the application or implementation without departing from the spirit or scope of the claims of the present disclosure. It is to be understood that the present disclosure is not limited in its application to the details of connections set forth in the following description. The present disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the terms “a” and “an” herein do not denote a limitation of quantity, but rather denote the presence of at least one of the referenced item. Furthermore, the terms “first,” “second,” and the like, herein do not denote any order, quantity, or importance, but rather are used to distinguish one element from another.

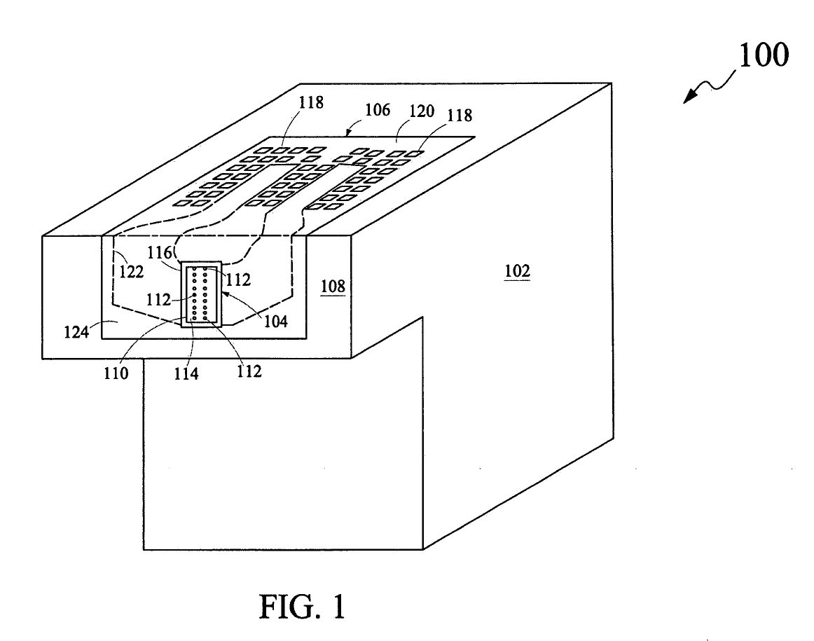

The present disclosure provides a thermally curable encapsulant composition for protecting a micro-fluid ejection head of an inkjet print cartridge, and even more specifically for protecting various electrical components of the inkjet print cartridge. The micro-fluid ejection head with the encapsulant composition may be advantageously employed in the inkjet print cartridge for increasing effective shelf-life of the inkjet print cartridge. Such an inkjet print cartridge employing the micro-fluid ejection head with the encapsulant composition is explained in conjunction with FIGS. 1, 2 and 3.

FIG. 1 a perspective view of an inkjet print cartridge, such as inkjet print cartridge 100, according to an embodiment of the present disclosure. As shown in FIG. 1, inkjet print cartridge 100 includes a fluid body 102, one or more micro-fluid ejection heads (hereinafter referred to as ‘micro-fluid ejection head 104’) and an electrical circuit, such as a flexible circuit 106. It should be apparent to a person skilled in the art that inkjet print cartridge 100 may include one or more electrical circuits that may either are flexible circuits, such as flexible circuit 106; or non-flexible circuits; or combinations thereof.

Fluid body 102 includes one or more chambers (not shown in the figure), with each of the one or more chambers including a fluid. Examples of the fluid include, but are not limited to, ink, a cooling fluid, and a lubricant. For the purpose of this description, the fluid used herein is ink. Further, the ink referred herein may include any color ink such as black color ink, cyan color ink, magenta color ink, yellow color ink, or combinations thereof.

Fluid body 102, employed in inkjet print cartridge 100, includes one or more fluid openings (not shown). During an inkjet printing process, the one or more fluid openings assist in transferring the ink from fluid body 102 to micro-fluid ejection head 104 disposed on an operative surface 108 of inkjet print cartridge 100. The term, ‘operative surface 108’ as used herein may be referred to as a surface of inkjet print cartridge 100 that is in contact with a printing medium. Micro-fluid ejection head 104 head includes a nozzle plate 110 having a plurality of nozzles 112, hereinafter referred to as “nozzles 112.” More specifically, nozzle plate 110 used herein is a photo-imageable nozzle plate. The photo-imageable nozzle plate provides excellent ink resistance in order to avoid any unnecessary deposition or holding of the ink in nozzles 112. It should be understood that micro-fluid ejection head 104 may include more than one nozzle plate 110. However, for the purpose of this description, micro-fluid ejection head 104 includes a single nozzle plate. Nozzle plate 110 includes a fluid-ejection surface 114 that encompasses nozzles 112. Fluid ejection surface 114 is used for ejecting the ink, received from fluid body 102, in a controlled manner through nozzles 112.

Micro-fluid ejection head 104 further includes a substrate 116. Substrate 116 includes resistors and/or other actuators, such as piezoelectric devices for inducing ejection of the ink through nozzles 112 of nozzle plate 110 towards the printing medium.

A controlled ejection of the ink from micro-fluid ejection head 104 onto the printing medium leads to formation of a printed character, a line, a dot, and such similar symbols, characters, and designs, thereby resulting in development of a printed image. Usually, such a controlled ejection of the ink from nozzles 112 may be facilitated through electrical signals from a print controller (not shown) employed in the inkjet printer. More specifically, the print controller may generate electrical signals and may transmit such electrical signals to micro-fluid ejection head 104 through flexible circuit 106. An exemplary flexible circuit 106 may be formed from a resilient polymeric film, such as a polyimide film. Moreover, flexible circuit 106 may include contact pads 118 that are configured on a first portion 120 of flexible circuit 106. In one aspect, contact pads 118 provide an electrical continuity between the print controller and flexible circuit 106. Further, flexible circuit 106 may include electrical traces 122 embedded through first portion 120 and a second portion 124 of flexible circuit 106.

Accordingly, flexible circuit 106 includes electrical connections that provide electrical contact between flexible circuit 106 and micro-fluid ejection head 104 configured adjacent to or in contact with second portion 124 of flexible circuit 106. More specifically, the electrical connections provide the electrical contact through contact pads 118 of flexible circuit 106 and substrate 116 of micro-fluid ejection head 104. Therefore, it should also be understood that the electrical connections provide an electrical continuity between the print controller and actuators of substrate 116 in order to regulate ejection of the ink through micro-fluid ejection head 104.

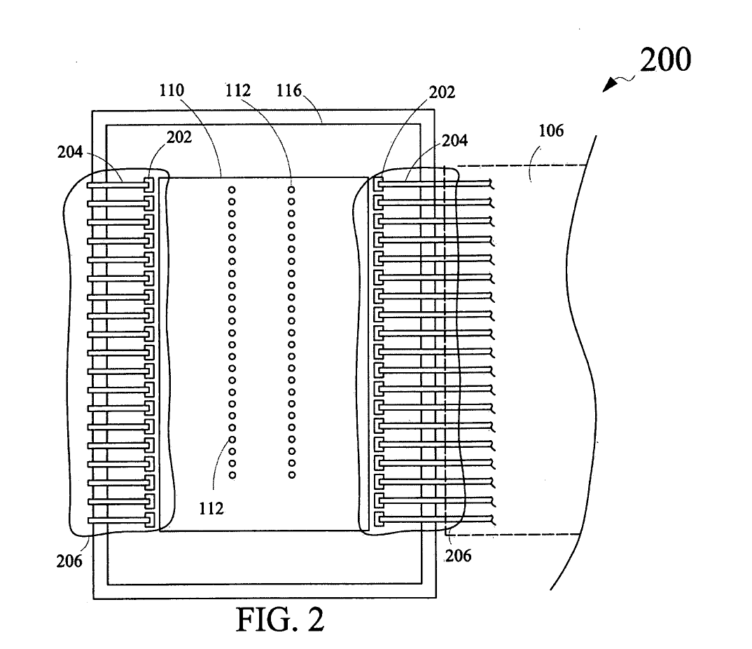

To avoid any direct contact of the ink with the aforementioned electrical components of the inkjet print cartridge that may lead to corrosion or abrasion thereof, an encapsulant composition (not shown in FIG. 1) may be disposed onto the electrical components for protection purposes. It should be understood that the electrical components include the electrical circuit, such as flexible circuit 106; the electrical connections; and electrical traces 122 of the inkjet print cartridge. More specifically, the encapsulant composition is disposed on a topside portion of the electrical components. Hereinafter, the encapsulant composition may interchangeably be referred to as a ‘topside encapsulant.’ Use of the encapsulant composition helps in increasing a shelf life of inkjet print cartridge 100 by reducing likelihood of corrosion or abrasion of the electrical components thereof. A portion of an inkjet print cartridge, such as inkjet print cartridge 100, employing the encapsulant composition of the present disclosure is explained in detail in conjunction with FIG. 2.

FIG. 2 is a top view of a portion of an inkjet print cartridge, such as inkjet print cartridge 100 of FIG. 1, with an encapsulant composition according to an embodiment of the present disclosure. Accordingly, reference numerals used for description of inkjet print cartridge 100 in FIG. 1 may be referred in the description of FIG. 2. As shown in FIG. 2, an inkjet print cartridge portion 200 includes various electrical connections, such as the electrical connections described in FIG. 1. The electrical connections are shown as an association of bond pads 202 configured on substrate 116 to contact pads (not shown in FIG. 2 but explained hereinafter as contact pads 118 with reference to FIG. 1). More specifically, bond pads 202 on substrate 116 are operatively connected to contact pads 118 on flexible circuit 106 by Tape Automated Bonding (TAB) techniques or by use of electrical wires using a wire bonding procedure through flexible circuit 106 and nozzle plate 110. For the purpose of this description, bond pads 202 are operatively connected to contact pads 118 through electrical wires 204. It should be understood that bond pads 202 electrically connect substrate 116 with flexible circuit 106.

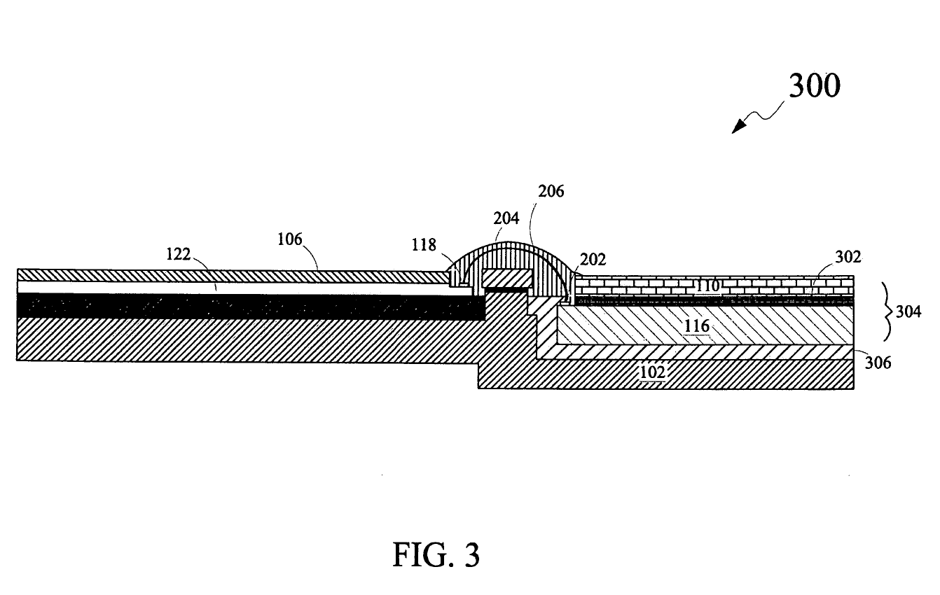

Further, to protect the electrical components from undergoing a short-circuit and ink corrosion, an encapsulant composition 206 is disposed onto the electrical components. More specifically, encapsulant composition 206 may be disposed onto the electrical components in such a way that encapsulant composition 206 may adhere to a portion of fluid-ejection surface 114 of micro-fluid ejection head 104. Therefore, it should be apparent to a person skilled in the art that encapsulant composition 206 may be disposed adjacent to fluid ejection surface 114 in order to encapsulate the electrical components. The electrical components as encapsulated with encapsulant composition 206, employed in an inkjet print cartridge, such as inkjet print cartridge 100, are further explained in conjunction with FIG. 3.

FIG. 3 is a cross-sectional side view (not to scale) of a portion of an inkjet print cartridge, such as inkjet print cartridge 100, with an encapsulant composition, such as encapsulant composition 206, according to an embodiment of the present disclosure. Accordingly, reference numerals used for description of FIGS. 1 and 2 may be referred in the description of FIG. 3. More specifically, FIG. 3 illustrates an inkjet print cartridge portion 300 having encapsulant composition 206. Inkjet print cartridge portion 300 illustrates substrate 116 that is bonded to nozzle plate 110 using an adhesive 302 to form a substrate-ejection surface assembly 304. For the purpose of this description, adhesive 302 may be a thermal cure resin such as a phenolic resin, a resorcinol resin, an epoxy resin, an ethylene-urea resin, a furane resin, a polyurethane resin and a silicone resin.

Further, as shown in FIG. 3, substrate-ejection surface assembly 304 may be secured to fluid body 102 using a die-bond adhesive 306. Die bond adhesive 306, as used herein, may be an epoxy adhesive such as a die bond adhesive available from Emerson & Cuming of Monroe Township, N.J. under trade name, ‘ECCOBOND 3193-17’. Other examples of such a die-bond adhesive may include POLY-SOLDER LT available from Alpha Metals of Cranston, R.I., and a die-bond adhesive available from Bryte Technologies of San Jose, Calif. under trade name, ‘G0063’.

In addition to the above, inkjet print cartridge portion 300 includes encapsulant composition 206, disposed in form of a bead on electrical components, such as the electrical components of FIGS. 1 and 2. More specifically, encapsulant composition 206 is disposed onto the electrical connections to provide protection to bond pads 202, contact pads 118 and electrical wires 204. It should be obvious to a person skilled in the art that the encapsulant composition, such as encapsulant composition 206, described herein requires curing after being disposed on a surface, such as fluid ejection surface 114. Consequently, encapsulant composition 206 may be thermally cured after being disposed to form a protective coating on the electrical components. The term “thermally cured” used herein refers to a method of hardening encapsulant composition 206 by heating to a temperature of greater than or equal to about 90 degrees Celsius (° C.). Further, it should be obvious to a person skilled in the art that encapsulant composition 206 may be disposed adjacent to micro-fluid ejection head 104 (not marked in figure) in order to encapsulate electrical traces 122 of flexible circuit 106, or electrical wires 204 and the electrical connections between electrical traces 122 and micro-fluid ejection head 104 of inkjet print cartridge 100.

Accordingly, in one aspect, the present disclosure provides a micro-fluid ejection head, such as micro-fluid ejection head 104, of an inkjet print cartridge, such as inkjet print cartridge 100. The micro-fluid ejection head includes a thermally curable encapsulant composition, such as encapsulant composition 206 that may be disposed adjacent to a fluid ejection surface, such as fluid ejection surface 114, of the micro-fluid ejection head. More specifically, the fluid-ejection surface may be a surface of a nozzle plate of the micro-fluid ejection head. The encapsulant composition, as used herein, includes from about 1.5 to about 95 percent by weight of at least one cross-linkable epoxy resin having a rigid backbone and from about 0.1 to about 35 percent by weight of at least one thermal curative agent. The at least one thermal curative agent may include a curative agent. Suitable examples of such a curative agent may include, but are not limited to, amines, imidazoles, antimonites, peroxides, accelerators, sulfur, and combinations thereof.

Further, the encapsulant composition may include at least one additional resin. Suitable examples of the at least one additional resin may include, but are not limited to, epoxy resins, silicone resin, urethane resin, butadiene resin, and combinations thereof. Furthermore, the encapsulant composition may include less than or equal to about 10 percent by weight of a silane coupling agent. In addition, the encapsulant formation may include less than or equal to about 80 percent by weight of at least one filler. Moreover, the encapsulant composition, as used herein, exhibits a glass transition temperature of greater than or equal to about 90 degrees Celsius upon curing at a temperature of greater than or equal to about 90 degrees Celsius.

In another aspect, the present disclosure provides a thermally curable encapsulant composition, such as encapsulant composition 206, for use in an inkjet print cartridge, such as inkjet print cartridge 100, that serves as an effective encapsulant composition for protecting surfaces of micro-fluid ejection heads, such as fluid-ejection surface 114 of micro-fluid ejection head 104 of FIG. 1, in order to insulate various electrical components encompassed by the surfaces of the micro-fluid ejection heads. Therefore, it should be apparent to a person skilled in the art that the encapsulant composition may be disposed adjacent to a surface of nozzle plate, such as nozzle plate 110 of FIG. 1, of the micro-fluid ejection heads. The encapsulant composition of the present invention includes from about 1.5 to about 95 percent by weight of at least one cross-linkable epoxy resin having a rigid backbone. The term ‘at least one cross-linkable epoxy resin having a rigid backbone’ may hereinafter interchangeably be referred to as a ‘cross-linkable epoxy resin’.

Suitable examples of such a cross-linkable epoxy resin include, but are not limited to, epoxidized bisphenol F (commercially available under trade name, ‘EXA 830 LVP’ from Dainippon Ink and Chemicals Inc, Japan), and epoxidized bisphenol A (commercially available under trade name, ‘EXA 850 CRP’ from Dainippon Ink and Chemicals Inc, Japan). Moreover, in addition to the cross-linkable epoxy resin, the encapsulant composition may further include at least one additional resin (hereinafter referred to as ‘additional resins’). Suitable examples of the additional resins include, but are not limited to, epoxy resins, silicone resins, urethane resins, butadiene resins, and combinations thereof.

The encapsulant composition further includes from about 0.1 to about 35 percent by weight of at least one thermal curative agent (hereinafter referred to as a ‘thermal curative agent’). The term “thermal curative agent” as used herein refers to a compound that reacts with the cross-linkable epoxy resin and the additional resins on application of heat energy for hardening purposes. The thermal curative agent may be a curative agent selected from amines, imidazoles, antimonites, peroxides, accelerators, sulfur, and combinations thereof. In an exemplary encapsulant composition, the thermal curative agent includes a solid amine with other curative agents as mentioned-above. More specifically, the solid amine has a melt temperature of less than or equal to about 65° C. A suitable example of such a solid amine is an amine adduct commercially available under trade name, ‘Ancamine 2337S’ (obtained from Air Products Inc.). It should be understood that solid amines with a melt temperature of about 100° C. may also be used as the thermal curative agent. Example of such a solid amine is an amine adduct commercially available under trade name, ‘Ancamine 2014’ (obtained from Air Products Inc.).

In addition to the foregoing components, the encapsulant composition may further include less than or equal to about 10 percent by weight of a silane coupling agent. The silane coupling agent used in the present disclosure provides a chemical bridge between the cross-linkable epoxy resin and any substance or material on which it may be deposited. For the purpose of this description, the silane coupling agent provides a chemical bridge, and hence, a strong adhesion between the encapsulant composition and the surfaces of the micro-fluid ejection heads. A specific example of such a silane coupling agent is an epoxy silane coupling agent. However, it may be understood that any other coupling agent that is compatible with the cross-linkable epoxy resin and the additional resins, and is capable of imparting the aforementioned properties to the encapsulant composition may be employed to serve the purpose of the present disclosure.

Furthermore, the encapsulant composition may include less than or equal to about 80 percent by weight of at least one filler, hereinafter referred to as ‘filler’. The filler for use in the encapsulant composition may be referred to as a compound that is used to improve physical properties of the encapsulant composition. Such physical properties may be referred to Theological properties that include viscosity of the encapsulant composition. A suitable example of the filler is fumed silica. However, it may be understood that any other filler that is compatible with cross-linkable epoxy resin and other additional resins, and is capable of imparting the aforementioned properties to the encapsulant composition may be employed to serve the purpose of the present disclosure. It should be understood that a large drop in viscosity of the encapsulant composition may affect dimensional control properties thereof resulting in scrap while manufacturing the inkjet print cartridge or the micro-fluid ejection heads. Accordingly, use of an optimum amount of the filler imparts good dimensional control properties to the encapsulant composition.

In yet another aspect, the present disclosure provides a method for protecting the micro-fluid ejection heads of the inkjet print cartridge. In general, any conventional method encompassing a thermal curing technique that is known in the art may be used. However, for the purposes of this description, the method for protecting a micro-fluid ejection head of an inkjet print cartridge includes disposing a thermally curable encapsulant composition adjacent to a fluid-ejection surface of the micro-fluid ejection head. More specifically, the encapsulant composition may be disposed on a surface of a nozzle plate of the micro-fluid ejection head. It should be understood that the encapsulant composition, as used herein, is similar to the encapsulant composition as disclosed-above. More specifically, the encapsulant composition, as used herein, includes from about 1.5 to about 95 percent by weight of at least one cross-linkable epoxy resin having a rigid backbone and from about 0.1 to about 35 percent by weight of at least one thermal curative agent. The at least one thermal curative agent includes a curative agent. Suitable examples of the curative agent may include, but are not limited to, amines, imidazoles, antimonites, peroxides, accelerators, sulfur, and combinations thereof.

Further, the encapsulant composition may include at least one additional resin. Suitable examples of the at least one additional resin may include, but are not limited to, epoxy resins, silicone resins, urethane resins, butadiene resins, and combinations thereof. Furthermore, the encapsulant composition may include less than or equal to about 10 percent by weight of a silane coupling agent. Additionally, the encapsulant composition may include less than or equal to about 80 percent by weight of at least one filler. Moreover, the encapsulant composition, as used herein, exhibits a glass transition temperature of greater than or equal to about 90 degrees Celsius. The method further includes curing the encapsulant composition as disposed on the fluid ejection surface. More specifically, the curing includes heating the encapsulant composition to a temperature greater than or equal to about 90° C. Upon the curing, the encapsulant composition exhibits an average edge migration of less than about 100 micrometers.

It should be obvious to a person skilled in the art that efficiency of the encapsulant composition of the present disclosure depends on types and quantities of the cross-linkable resin, the thermal curative agent, the silane coupling agent, and the filler. The foregoing aspects of the present disclosure may be understood by referring to the following non-limiting example. However, one of ordinary skill in the art, and based on a reading of this detailed description, would recognize that, the specific example is intended to illustrate, and not limit, the scope of the present disclosure.

### EXAMPLE

In the following example, an encapsulant composition of the present disclosure was evaluated for different properties thereof. It is to be understood that the encapsulant composition and the evaluation results described herein provide an exemplary illustration of the present disclosure and should not be construed as a limitation of the present disclosure.

Table 1 shows components of an exemplary encapsulant composition, hereinafter referred to as ‘Encapsulant Composition I’.

TABLE 1

| | | Concentration | | |
|---|---|---|---|---|
| | | Range (percent | | |
| Component | Material | by weight) | Trade Name | Supplier |
| Cross-linkable | Epoxidized | 62.58-64.84 | EXA 830 | Dainippon Ink and |
| Epoxy Resin | bisphenol F | | LVP | Chemicals Inc |
| | Epoxidized | 6.95-7.20 | EXA 850 | Dainippon Ink and |
| | bisphenol A | | CRP | Chemicals Inc |
| Thermal curing | Amine adduct 1 | 10.43-10.80 | Ancamine | Air Products and |
| agent | | | 2337S | Chemical Inc |
| | Amine adduct 2 | 15.85-16.42 | Ancamine | Air Products and |
| | | | 2014 | Chemical Inc |
| Silane coupling | Epoxy silane | 0.69-0.72 | A-187 | Crompton |
| agent | | | | Corporation |
| Filler | Fumed silica | Less than 3.47 | TS-720 | Cabot Corporation |

The Encapsulant Composition I was evaluated for use in an inkjet print cartridge, such as inkjet print cartridge 100 of FIG. 1. More specifically, the evaluation was carried out to analyze different properties of the Encapsulant Composition I when disposed adjacent to micro-fluid ejection heads of the inkjet print cartridge. The properties that were analyzed included Young's modulus (E), Storage modulus (G′), and Glass transition temperature (T_{g}). For experimental purposes, the Storage modulus was measured using TA Instruments ARES Rheometer at a temperature of about 25° C. after cure. Further, the glass transition temperature was measured by modulated differential scanning calorimetry (MDSC).

It should be understood that the aforementioned properties were monitored and analyzed for the Encapsulant Composition I that included the components of Table 1 at any concentration that is covered within the ranges specified. Further, the properties of the Encapsulant Composition I of Table 1 were analyzed and compared to properties of a conventional encapsulant composition available from Engineered Materials Systems, Inc. of Delaware, Ohio under trade name, ‘EMS 502-39-1’. Results of a comparative analysis of the properties of the conventional encapsulant composition with the properties of the Encapsulant Composition I of the present disclosure are shown in Table 2.

TABLE 2

| | | Storage Modulus | Glass transition |
|---|---|---|---|
| Encapsulant | Young's Modulus | (G′) at 25° C. | temperature |
| composition | (E) at 25° C. (MPa) | (GPa) | (T_{g}) (° C.) |
| EMS 502-39-1 | 2000 | 0.428 | 80 |
| (Conventional | | | |
| Encapsulant | | | |
| Composition) | | | |
| Encapsulant | 2000 | 1.185 | 102 |
| Composition I | | | |

It should be apparent to a person skilled in the art that, the term ‘Young's modulus’ used herein may be defined as the ratio of tensile stress to tensile strain as shown in Equation (1) below:

Young's modulus (E)=Tensile stress/Tensile strain (1)

As used herein, the tensile stress is defined in terms of a force ‘F’ that may be applied across an area ‘A’ of a solid object, and tensile strain is defined in terms of change in length (delta L) of the object of length ‘L’ when the force is applied.

Further, the term ‘Storage modulus’ is used in dynamic mechanical testing of viscoelastic materials, and is defined according to below-mentioned Equation (2) where τ′ is the in-phase shear stress and γ′ is the in-phase shear strain.

Storage modulus (G′)=τ′/γ′ (2)

As used herein, the shear stress is defined in terms of a force ‘F’ applied across the area ‘A’ of the solid object, and shear strain is defined in terms of a change in traversal length (delta x) of the object of traversal length ‘H.’

Furthermore, the term ‘Glass transition temperature’ of a material with elastic properties is the temperature at which the material undergoes transitions to more brittle physical properties or more elastic physical properties, depending on whether the temperature is decreasing or increasing, respectively.

Referring again to Table 2, it may be seen that the Encapsulant Composition I exhibits a Young's modulus of about 2000 Mega Pascal (MPa), and a Storage modulus 1.1 GPa at a temperature of about 25° C. It should be understood that encapsulant compositions, such as the Encapsulant Composition I, of the present disclosure may exhibit a Young's modulus of greater than or equal to about 1500 MPa and a Storage modulus of greater than or equal to about 0.5 GPa.

For providing adequate protection to the micro-fluid ejection heads, it is desired that the Encapsulant Composition I should exhibit low deformation when subjected to shearing forces. In light of the aforementioned values of Young's modulus, it should be understood that the Encapsulant Composition I exhibits a relatively low deformation under shearing forces in comparison to the conventional encapsulant composition. The aforementioned advantage of the Encapsulant Composition I helps in providing adequate protection to the micro-fluid ejection heads, thereby increasing shelf life of the inkjet print cartridge.

For providing adequate protection to the micro-fluid ejection heads, it is desired that the Encapsulant Composition I should exhibit high reversible deformation behavior when subjected to shearing forces. In light of the aforementioned values of Storage modulus, it should be understood that the Encapsulant Composition I exhibits a relatively high reversible deformation behavior under shearing forces in comparison to the conventional encapsulant composition. The aforementioned advantage of the Encapsulant Composition I helps in providing adequate protection to the micro-fluid ejection heads, thereby increasing shelf and operating life of the inkjet print cartridge.

Additionally, it may be seen that the Encapsulant Composition I exhibits a glass transition temperature of about 102° C. As seen in Table 2, Encapsulant Composition I exhibits a higher glass transition temperature in comparison to the conventional encapsulant composition. Therefore, it should be understood that on cooling the Encapsulant Composition I after performing curing thereof, the Encapsulant Composition I exhibits good rigidity. However, the Encapsulant Composition I may exhibit a glass transition temperature of greater than or equal to about 90° C. in order to serve as an effective encapsulant composition for use in the inkjet print cartridge. Therefore, encapsulant compositions, such as the Encapsulant Composition I, of the present disclosure, may exhibit any acceptable value of the glass transition temperature covered under the aforementioned range to serve as an ideal encapsulant composition for protecting micro-fluid ejection heads of inkjet print cartridges.

Moreover, the Encapsulant Composition I exhibits a low average edge migration of less than about 100 micrometers (μm) upon curing. More specifically, the Encapsulant Composition I exhibits an average edge migration of about 10 μm. Based on the foregoing properties, the Encapsulant Composition I strongly and rigidly adheres adjacent to the micro-fluid ejection heads, thereby reducing any likelihood of flowing over nozzle plate of the micro-fluid ejection heads. The said property of the Encapsulant Composition I helps in reducing any possibility of blocking nozzles of the nozzle plate that are required for ejection of the ink. In addition, while conducting plasma cleaning of material of the nozzle plate using tools such as wipers, the rigid and strong adhesion properties of the Encapsulant Composition I impart an improved wiper wear resistance to the fluid-ejection surface of the nozzle plate, thereby, reducing occurrence of corrosion and abrasion caused by use of the wipers over the nozzle plate.

Accordingly, the present disclosure provides an effective thermally curable encapsulant composition for protecting micro-fluid ejection heads of an inkjet print cartridge. The encapsulant composition is a relatively rigid and exhibits a high glass transition temperature. Further, the encapsulant composition provides a good adhesion to surfaces of the micro-fluid ejection heads, such as a surface of a nozzle plate, and more specifically a surface of a photo-imageable nozzle plate. More specifically, the encapsulant composition serves as a topside encapsulant composition for protecting electrical components that are encompassed by the micro-fluid ejection heads of the inkjet print cartridge. Furthermore, the encapsulant composition exhibits a low edge migration upon thermal curing, thereby exhibiting a rigid and strong adherence to the surfaces of the micro-fluid ejection heads. Additionally, the encapsulant composition exhibits a high ink resistance to reduce any likelihood of corrosion of the micro-fluid ejection heads by preventing any deposition of the ink thereon. Therefore, the encapsulant composition of the present disclosure is capable of increasing shelf life of the inkjet print cartridge.

The foregoing description of several embodiments and methods of the present disclosure have been presented for purposes of illustration. It is not intended to be exhaustive or to limit the present disclosure to the precise steps and/or forms disclosed, and obviously many modifications and variations are possible in light of the above teaching. It is intended that the scope of the present disclosure be defined by the claims appended hereto.

1. A thermally curable encapsulant composition for a micro-fluid ejection head of an inkjet print cartridge, the encapsulant composition comprising:
from about 1.5 to about 95 percent by weight of at least one cross-linkable epoxy resin having a rigid backbone; and
from about 0.1 to about 35 percent by weight of at least one thermal curative agent,
wherein the encapsulant composition exhibits a glass transition temperature of greater than or equal to about 90 degrees Celsius upon curing at a temperature of greater than or equal to about 90 degrees Celsius.

2. The encapsulant composition of claim 1 further comprising at least one additional resin selected from the group consisting of epoxy resins, silicone resins, urethane resins, butadiene resins, and combinations thereof.

3. The encapsulant composition of claim 1 wherein the at least one thermal curative agent comprises a curative agent selected from the group consisting of amines, imidazoles, antimonites, peroxides, accelerators, sulfur, and combinations thereof.

4. The encapsulant composition of claim 3 wherein the at least one thermal curative agent comprises:
a solid amine having a melt temperature of less than or equal to about 65 degrees Celsius; and
a curative agent selected from the group consisting of amines, imidazoles, antimonites, peroxides, accelerators, sulfur, and combinations thereof.

5. The encapsulant composition of claim 1 further comprising less than or equal to about 10 percent by weight of a silane coupling agent.

6. The encapsulant composition of claim 1 further comprising less than or equal to about 80 percent by weight of at least one filler.

7. A method for protecting a micro-fluid ejection head of an inkjet print cartridge, the method comprising:
disposing a thermally curable encapsulant composition adjacent to a fluid-ejection surface of the micro-fluid ejection head, the encapsulant composition comprising,
from about 1.5 to about 95 percent by weight of at least one cross-linkable epoxy resin having a rigid backbone, and
from about 0.1 to about 35 percent by weight of at least one thermal curative agent,
wherein the encapsulant composition exhibits a glass transition temperature of greater than or equal to about 90 degrees Celsius; and
curing the encapsulant composition, the curing comprising heating the encapsulant composition to a temperature greater than or equal to about 90 degrees Celsius.

8. The method of claim 7 wherein the encapsulant composition further comprises at least one additional resin selected from the group consisting of epoxy resins, silicone resins, urethane resins, butadiene resins, and combinations thereof.

9. The method of claim 7 wherein the encapsulant composition exhibits an average edge migration of less than about 100 micrometers upon the curing.

10. The method of claim 7 wherein the at least one thermal curative agent comprises a curative agent selected from the group consisting of amines, imidazoles, antimonites, peroxides, accelerators, sulfur, and combinations thereof.

11. The method of claim 7 wherein the encapsulant composition further comprises less than or equal to about 10 percent by weight of a silane coupling agent.

12. The method of claim 7 wherein the encapsulant composition further comprises less than or equal to about 80 percent by weight of at least one filler.

13. A micro-fluid ejection head of an inkjet print cartridge, the micro-fluid ejection head comprising:
a thermally curable encapsulant composition disposed adjacent to a fluid ejection surface of the micro-fluid ejection head, the encapsulant composition comprising,
from about 1.5 to about 95 percent by weight of at least one cross-linkable epoxy resin having a rigid backbone; and
from about 0.1 to about 35 percent by weight of at least one thermal curative agent,
wherein the encapsulant composition exhibits a glass transition temperature of greater than or equal to about 90 degrees Celsius upon curing at a temperature of greater than or equal to about 90 degrees Celsius.

14. The micro-fluid ejection head of claim 13 wherein the fluid-ejection surface is a surface of a nozzle plate.

15. The micro-fluid ejection head of claim 13 wherein the encapsulant composition further comprises at least one additional resin selected from the group consisting of epoxy resins, silicone resin, urethane resin, butadiene resin, and combinations thereof.

16. The micro-fluid ejection head of claim 13 wherein the at least one thermal curative agent comprises a curative agent selected from the group consisting of amines, imidazoles, antimonites, peroxides, accelerators, sulfur, and combinations thereof.

17. The micro-fluid ejection head of claim 13 wherein the encapsulant composition further comprises less than or equal to about 10 percent by weight of a silane coupling agent.

18. The micro-fluid ejection head of claim 13 wherein the encapsulant formation further comprises less than or equal to about 80 percent by weight of at least one filler.
